(19) United States
(12) Patent Application Publication
(10) Pub. No.: US 2021/0188711 A1
(43) Pub. Date: Jun. 24, 2021

(54) METHODS AND SYSTEMS FOR PROVIDING IMPROVED CEMENT INCORPORATING METAL OXIDES AND HYDROXIDES

(71) Applicants: Shiho Kawashima, Brooklyn, NY (US); Daniel V. Esposito, New York, NY (US); Siwei Ma, San Jose, CA (US); Abdullah Huzeyfe Akca, New York, NY (US)

(72) Inventors: Shiho Kawashima, Brooklyn, NY (US); Daniel V. Esposito, New York, NY (US); Siwei Ma, San Jose, CA (US); Abdullah Huzeyfe Akca, New York, NY (US)

(73) Assignee: The Trustees of Columbia University in the City of New York, New York, NY (US)

(21) Appl. No.: 17/132,785

(22) Filed: Dec. 23, 2020

Related U.S. Application Data
(60) Provisional application No. 62/953,251, filed on Dec. 24, 2019.
(60) Provisional application No. 63/083,311, filed on Sep. 25, 2020.
(60) Provisional application No. 63/129,110, filed on Dec. 22, 2020.

(51) Int. Cl. C04B 28/10; C04B 2/10; C04B 2/02; C04B 7/40; C25B 1/34; C25B 15/08; C25B 9/17; C25B 1/50

(52) U.S. Cl. CPC C04B 28/105; C04B 2/102; C04B 2/02; C25B 1/50; C25B 1/34; C25B 15/087; C25B 9/17; C04B 7/40

(57) ABSTRACT

Cement and concrete compositions are produced via metal hydroxides and metal oxides isolated from aqueous sources such as seawater or wastewater. Aqueous solutions are electrolyzed to produce an alkaline component stream having an elevated pH, which when mixed with mineralized seawater causes metal ions dissolved therein to precipitate out in the form of metal hydroxides such as Mg(OH)₂ and Ca(OH)₂. These metal hydroxide products are then utilized as feedstocks for production of cement and concrete structural elements, or are converted to metal oxides suitable for the same purpose. The hydroxide products are then subjected to pressure and prolonged exposure to carbon dioxide to accelerate carbonation of the hydrated product. The resulting carbonates exhibit sufficient compressive strength for use in making structural components for construction, while reducing or eliminating the carbon footprint associated with traditional methods of cement and concrete manufacturing. Excess demineralized alkaline component can be recycled for additional electrolysis, or returned to a neutral pH for use in water desalination processes or even returned to the environment.

### CROSS REFERENCE TO RELATED APPLICATION(S)

This application claims the benefit of U.S. Provisional Application Nos. 62/953,251, filed Dec. 24, 2019, 63/083,311, filed Sep. 25, 2020, and 63/129,110, filed Dec. 22, 2020, which are incorporated by reference as if disclosed herein in their entireties.

### BACKGROUND

Magnesium oxide (MgO)-based cement has over 150 years of history since Sorel cement was invented by Santislas Sorel in 1866. Typically, MgO-based cement is made by mixing calcined MgO powders with various types of concentrated solutions, such as magnesium chloride (MgCl₂), magnesium sulfate (MgSO₄), and phosphoric acid (H₃PO₄), and forming the binary hydrated product (such as 5MgO.MgCl₂.13H₂O). When calcined reactive MgO is mixed with plain water, reactive MgO powder will react with water to form brucite (Mg(OH)₂), which has a porous structure and is typically quite low in strength. However, there exists a reawakened interest in MgO—H₂O systems as they exhibit the ability to absorb CO₂, forming carbonated products as strong as hydrated Portland cement. Recently, various aspects of the carbonation of reactive MgO have been investigated, including carbonation condition, microstructure, additives that enhance hydration and carbonation, durability, and life cycle assessment. MgO—H₂O systems hold great promise as low-carbon alternative binders to replace conventional Portland cement in application, including porous blocks, concrete, and ground improvement.

The signs of global warming and climate change, such as melting glaciers, flooding, and heat waves, has sparked significant research efforts towards developing various technologies to stop or slow down the impacts of these climate disasters. Increasing levels of greenhouse gases like carbon dioxide (CO₂) in the atmosphere is the primary reason for global warming. Today, concrete is the second most consumed substance in the world after water, and its main ingredient, Portland cement, is the second highest industrial source of CO₂ on the planet. If nothing changes in the way cement is manufactured, cement is posed to contribute an even higher percentage of carbon emissions as concrete demand continues to increase, especially in developing countries.

Increased carbon dioxide (CO₂) emissions is the most significant environmental challenge of this century. Manufacturing of cement is responsible for about 5˜7 percent of global greenhouse gas emissions. Conventional feedstock for Portland cement manufacturing is limestone (CaCO₃), which is excavated and crushed. Then it is sintered with other materials (e.g., clays) at temperatures reaching ˜1450° C. in a cement kiln to produce clinker. This process directly releases CO₂ during calcination of CaCO₃ (such as via CaCO₃→CaO+CO₂), which makes up ˜50-60% of the total emissions of Portland cement production.

Several cementitious materials such as alkali-activated materials, reactive belite, and carbonate binders have been developed to lower the carbon footprint of concrete. Carbon dioxide sequestration in concrete has recently been proposed as a potential solution due to the fact that CO₂ reacts with cations such as Ca²⁺, Mg²⁺, and Li²⁺ that are present in cement to form highly stable carbonates, which can also improve mechanical properties over time. However, the potential CO₂ storage capacity of Portland cement concretes is significantly lower than the CO₂ emitted during their production. Therefore, the development and production of eco-efficient alternatives to carbon-intensive Portland cement is important.

Mg-based cements are promising given the high abundance of Mg in the earth's crust and seawater, which can be excavated or precipitated in forms such as magnesite, dolomite, and magnesium hydroxide. Although many forms of Mg-based cements exist, as discussed above, reactive magnesium oxide or magnesia (MgO) is best known for its ability to react with CO₂ in the presence of water to form carbonates. The key reactions are as follows:

MgO+H₂O→Mg(OH)₂ (Brucite)

Mg(OH)₂+CO₂+2H₂O→MgCO₃.3H₂O (Nesquehonite)

5Mg(OH)₂+4CO₂→4MgCO₃.Mg(OH)₂.4H₂O (Hydromagnesite)

5Mg(OH)₂+4CO₂+H₂O→4MgCO₃.Mg(OH)₂.5H₂O (Dypingite)

When sourced from magnesite (MgCO₃), it has been found that the carbon footprint of the resultant concrete can be higher than that of Portland cement due to the higher energy consumption of producing MgO from MgCO₃ than Portland cement clinker (4.096 GJ/ton vs. 2.52 GJ/ton, respectively). Also, similar to the calcination of limestone to produce CaO for Portland cement, calcination of MgCO₃ to produce MgO results in the direct release of CO₂. From a sustainability perspective, the cement industry is calling for alternative binders that can reduce associated CO₂ emissions without compromising performance.

### SUMMARY

Some embodiments of the present disclosure are directed to a method of making a cementitious composition including providing an aqueous source of metal ions, providing an aqueous demineralized feedstream to an electrochemical device, isolating an alkaline component and an acidic component from the aqueous demineralized feedstream, mixing the aqueous source of metal ions and the alkaline component to form an aqueous mixture, and precipitating metal hydroxides from the aqueous mixture to form a metal hydroxide product and a demineralized alkaline component, the metal hydroxide product including metal ions from the aqueous source of metal ions. In some embodiments, the method includes recycling at least a portion of the demineralized alkaline component to the electrochemical device as the aqueous demineralized feedstream. In some embodiments, the method includes combining the acidic component with at least a portion of the demineralized alkaline component as a demineralized aqueous source product. In some embodiments, the method includes incorporating the metal hydroxide product into a cementitious composition. In some embodiments, the aqueous source includes seawater, brine, brackish water, wastewater, or combinations thereof. In some embodiments, the metal ions include magnesium, calcium, or combinations thereof.

In some embodiments, incorporating the metal hydroxide product into a cementitious composition includes providing a composition of metal hydroxide product and contacting the metal hydroxide product composition with a source of carbon dioxide and a source of H₂O. In some embodiments, contacting the metal hydroxide product with a source of carbon dioxide and a source of H₂O includes providing H₂O to the metal hydroxide product to form a slurry having a water-to-solids ratio of about 0.2 to about 0.3 by mass, compacting the slurry at a pressure to form a compacted slurry, and exposing the compacted slurry to an environment having a concentration of carbon dioxide of at least about 20%. In some embodiments, the pressure is about 3 MPa. In some embodiments, the compacted slurry is exposed to the carbon dioxide for about 2 to about 5 days. In some embodiments, the step of contacting the metal hydroxide product with a source of carbon dioxide and a source of H₂O are repeated to additively form a multilayered concrete structural element. In some embodiments, contacting the metal hydroxide product with a source of carbon dioxide and a source of H₂O includes pelletizing the metal hydroxide product composition with sprayed water and exposing the pelletized metal hydroxide composition to the source of carbon dioxide.

Some embodiments of the present disclosure are directed to a method of making a cementitious composition including providing an aqueous source of metal ions, providing an aqueous demineralized feedstream to an electrochemical device, isolating an alkaline component and an acidic component from the aqueous demineralized feedstream, mixing the aqueous source of metal ions and the alkaline component to form an aqueous mixture, precipitating metal hydroxides from the aqueous mixture to form a metal hydroxide product and a demineralized alkaline component, the metal hydroxide product including metal ions from the aqueous source of metal ions, heating the metal hydroxide product to form a metal oxide product, and incorporating the metal oxide product into a cementitious composition. In some embodiments, the method includes contacting at least a portion of the demineralized alkaline component with a source of carbon dioxide to form a carbonate product and providing the carbonate product to the slurry.

In some embodiments, incorporating the metal oxide product into a cementitious composition includes mixing the metal oxide product with a source of water to form a slurry and exposing the slurry to a source of carbon dioxide. In some embodiments, exposing the slurry to a source of carbon dioxide includes extruding a first layer of slurry in an environment having a concentration of carbon dioxide of about 20% and extruding at least one subsequent layer of slurry over the first layer of slurry. In some embodiments, incorporating the metal oxide product into a cementitious composition includes pelletizing the metal oxide product with sprayed water and exposing the pelletized metal oxide product to carbon dioxide.

Some embodiments of the present disclosure are directed to a system for making a cementitious composition including an aqueous source of metal ions; a membraneless electrolyzer, including a first input in fluid communication with an aqueous demineralized feedstream, a first outlet stream including an alkaline component, and a second outlet stream including an acidic component; a precipitation tank in fluid communication with the first outlet stream and the aqueous source of metal ions, the precipitation tank including a demineralized alkaline component outlet stream; a neutralization tank in fluid communication with the second outlet stream and the demineralized alkaline component outlet stream, the neutralization tank having a third outlet stream including a demineralized aqueous source product; and a recycle stream in fluid communication with the demineralized alkaline component outlet stream and the first input to provide least a portion of the demineralized alkaline component outlet stream to the membraneless electrolyzer as the aqueous demineralized feedstream.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a system for making a cementitious composition according to some embodiments of the present disclosure;

FIG. 2A is a chart of method of making a cementitious compositions according to some embodiments of the present disclosure;

FIG. 2B is a chart of method of making a cementitious compositions according to some embodiments of the present disclosure;

FIG. 3A is a chart of method of making a cementitious compositions according to some embodiments of the present disclosure;

FIG. 3B is a chart of method of making a cementitious compositions according to some embodiments of the present disclosure;

FIG. 4A is a graph of thermogravimetric analysis (TGA) results for standard Mg(OH)₂ and seawater-derived Mg(OH)₂ according to some embodiments of the present disclosure;

FIG. 4B is a graph of X-ray diffraction (XRD) results for standard Mg(OH)₂ and seawater-derived Mg(OH)₂ according to some embodiments of the present disclosure;

FIG. 5 is a graph of particle size distribution of standard vs. seawater-derived precipitated Mg(OH)₂ according to some embodiments of the present disclosure;

FIG. 6A is a graph of TGA results comparing standard versus seawater-derived samples cured in a pure CO₂ environment according to some embodiments of the present disclosure; and

FIG. 6B is a graph of XRD results comparing standard versus seawater-derived samples cured in a pure CO₂ environment according to some embodiments of the present disclosure.

### DETAILED DESCRIPTION

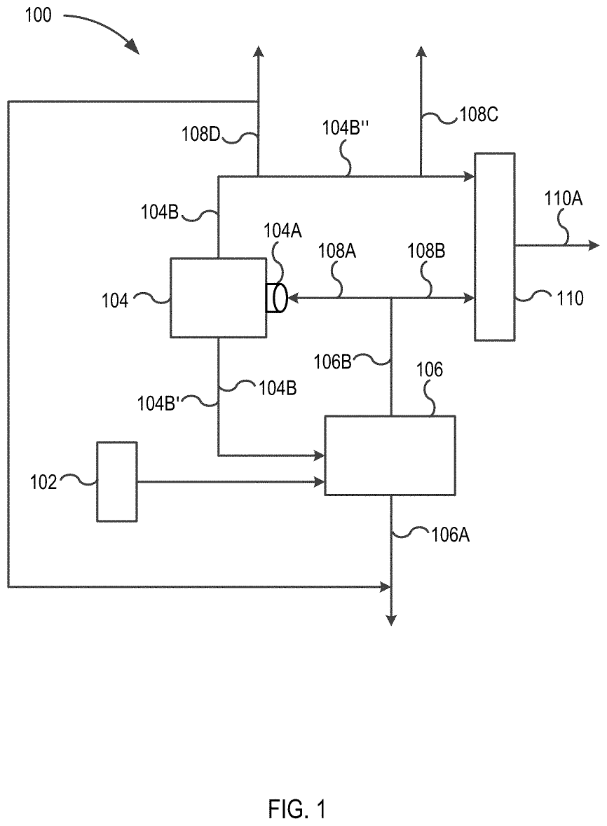

Referring now to FIG. 1, some embodiments of the present disclosure are directed to a system 100 for making a cementitious composition. In some embodiments, system 100 produces one or more feedstocks for incorporation into and improvement of traditional cementitious compositions. In some embodiments, system 100 produces one or more feedstocks for use in novel cementitious compositions. The cementitious compositions produced by system 100 can then be used to create concrete structural elements, as will be discussed in greater detail below. In some embodiments, the feedstocks produced by system 100 include one or more metal hydroxides, one or more metal oxides, compositions including the one or more metal hydroxides, compositions including the one or more metal oxides, or combinations thereof. In some embodiments, the feedstocks produced by system 100 include one or more metal carbonates, compositions including the one or more metal carbonates, or combinations thereof. In some embodiments, the metal hydroxides and/or metal oxides include one or more metal ions. In some embodiments, at least a portion of the metal ions are from an aqueous source via a process that will be discussed in greater detail below. In some embodiments, the metal ions are any metal ion that, as part of a hydroxide or oxide compound, are suitable for use in cement and/or in concrete structural elements. In some embodiments, the metal ions include magnesium ions, calcium ions, or combinations thereof. In some embodiments, the aqueous source is any source having the above-identified metal ions dissolved therein.

Still referring to FIG. 1, system 100 includes an aqueous source of metal ions 102. In some embodiments, the aqueous source includes seawater, brine, brackish water, wastewater, or combinations thereof. In some embodiments, the metal ions include magnesium ions, calcium ions, or combinations thereof. In some embodiments, system 100 includes one or more electrochemical devices 104. In some embodiments, electrochemical device 104 includes at least a first input 104A that is in communication with an aqueous demineralized feedstream. In some embodiments, the aqueous demineralized feedstream includes a reduced concentration of potential scalants, foulants, etc., or combinations thereof. In some embodiments, the aqueous demineralized feedstream includes a reduced concentration of metal ions. In some embodiments, electrochemical device 104 includes at least one outlet stream 104B. In some embodiments, electrochemical device 104 includes a plurality of outlets streams 104B. In some embodiments, at least one of outlet streams 104B is includes an alkaline component, e.g., 104B′ from FIG. 1. In some embodiments, at least one of outlet streams 104B is includes an acidic component, e.g., 104B″ from FIG. 1.

Electrochemical device 104 includes any suitable components to generate alkaline component 104B′ from the aqueous demineralized feedstream and isolate the alkaline component from acidic component 104B″. In some embodiments, electrochemical device 104 includes one or more electrolyzers, electrodialysis cells, or combinations thereof. In some embodiments, electrochemical device 104 is a membraneless electrolyzer. In some embodiments, aqueous source 102 is fed continuously, semi-continuously, as a batch process, or combinations thereof, to electrochemical device 104. In some embodiments, to aid in precipitation of the metal ions from aqueous source 102, additional hydroxide is added to the aqueous source, alkaline component 104B′, or combinations thereof. In some embodiments, the additional hydroxide is NaOH or other suitable hydroxide.

Still referring to FIG. 1, in some embodiments, at least one outlet stream 104B is in fluid communication with a precipitation tank 106. In some embodiments, an amount of aqueous source 102 is fed to precipitation tank 106 to mix with alkaline component 104B′ from outlet stream 104B to form an aqueous mixture. In some embodiments, precipitation tank 106 includes an initial source of hydroxyls. In some embodiments, the initial source of hydroxyls aids in forming the aqueous mixture with aqueous source 102 where there is little to no alkaline component 104B′ available. In some embodiments, the initial source of hydroxyls includes a concentration of KOH, NaOH, etc., or combinations thereof. Precipitation tank 106 can be of any suitable configuration to allow precipitation and isolation of a product from the aqueous mixture. In an exemplary embodiment, Mg²⁺ ions can be converted into solid Mg(OH)₂ (brucite) through the following chemical reaction with OH⁻:

Mg²⁺+2OH⁻→Mg(OH)₂₍ₛ₎ Kₛₚ^{o}=5.61×10⁻¹² M³

where Kₛₚ^{o} is the solubility product constant at 25° C. Consistent with Le Chatelier's principle, increasing pH shifts equilibrium of this reaction to the right, leading soluble Mg²⁺ to rapidly convert into insoluble Mg(OH)₂ particles. Thus, by splitting the aqueous demineralized feedstream into reduced-pH acidic component 104B′ and elevated-pH alkaline component 104B′ via an electrolysis process and subsequent mixing of the alkaline component with aqueous source 102, system 100 is able to induce precipitation of metal ions from that source, e.g., in the form of Mg(OH)₂ from the aqueous mixture with the Mg component coming from aqueous source 102, which can then be collected as a product and repurposed.

As discussed above, in some embodiments, outlet stream 104B includes alkaline component 104B′. Alkaline component 104B′ is provided to precipitation tank 106, raising the pH and causing metal ions to convert to insoluble compounds and precipitate out of solution, forming a precipitated product and a demineralized stream, e.g., demineralized alkaline component outlet stream 106B. In some embodiments, the precipitated product is separated from the demineralized stream via a separation module. The separation module can have any suitable configuration to isolate the precipitated product from the demineralized stream. In some embodiments, the separation module is integrated with precipitation tank 106. In some embodiments, the separation module is a component of system 100 separate from precipitation tank 106. In some embodiments, the separation module includes a rotary drum filter. In some embodiments, the precipitated product is removed from precipitation tank 106 continuously, semi-continuously, in a batch process, or combinations thereof. In some embodiments, precipitation tank 106 includes a product stream 106A for removing the precipitated product from the tank. In some embodiments, the precipitated product includes one or more compounds including metal ions from aqueous source 102. In some embodiments, the one or more compounds include metal hydroxides. In some embodiments, the metal hydroxides are incorporated into a cementitious composition, further processed for use in a cementitious composition, or combinations thereof, as will be discussed in greater detail below.

Referring again to FIG. 1, in some embodiments, as discussed above, precipitation tank 106 includes a demineralized alkaline component outlet stream 106B. In some embodiments, at least a portion of demineralized alkaline component outlet stream 106B (e.g., 108A in FIG. 1) is recycled to electrochemical device 104 at input 104A as the aqueous demineralized feedstream, where it again undergoes electrolysis, producing additional acidic component 104B″ and alkaline component 104B′. In some embodiments, a separate aqueous demineralized feedstream from any suitable external source (not pictured) can be provided to electrochemical device 104, either in addition to or in place of stream 108A. In some embodiments, at least a portion of demineralized alkaline component outlet stream 106B (e.g., 108B in FIG. 1) is fed to a neutralization tank 110. In some embodiments, an outlet stream 104B including an acidic component 104B″ is also fed to neutralization tank 110. In these embodiments, the addition of acidic component 104B″ aids in neutralizing the pH of the portion of demineralized alkaline component outlet stream 108B in neutralization tank 110 and produce a demineralized aqueous source product stream 110A. In some embodiments, demineralized aqueous source product stream 110A is suitable to be returned to the origin of aqueous source 102, e.g., the ocean, sent to a water desalination plant, or combinations thereof. Demineralized seawater is of great interest for the water desalination industry because alkali earth metal hydroxides are well-known to result in scaling on the surfaces of membranes of water desalination units. In some embodiments, a portion of an acidic component 104B″ is first removed as excess acid at 108C. In some embodiments, the reduced pH of acidic component 104B″ causes a concentration of carbon dioxide to come out of solution of acidic component 104B″ as carbon dioxide effluent stream 108D.

As discussed above, the precipitated product produced by system 100 is suitable for use in the production of cement. In an exemplary embodiment, metal hydroxides from precipitation tank 106 can be used as a substitute for limestone and other traditional feedstocks in the production of cement, which can help cut the carbon footprint by more than half while still utilizing existing plant infrastructure and mixing/building standards. In other exemplary embodiments, metal hydroxide and/or metal oxide products can be used as binders of inert aggregate for the formation of concrete and concrete structural elements having desired conformations. In some embodiments, at least a portion of carbon dioxide effluent stream 108D is reused in processing of the precipitated product into cementitious compositions and/or concrete structural elements, as will be discussed in greater detail below.

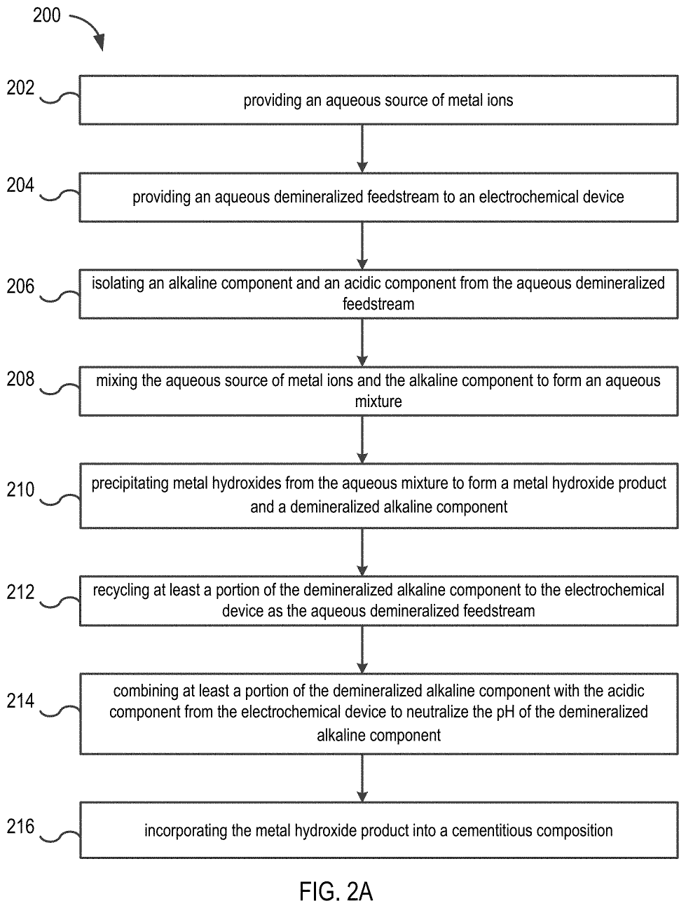

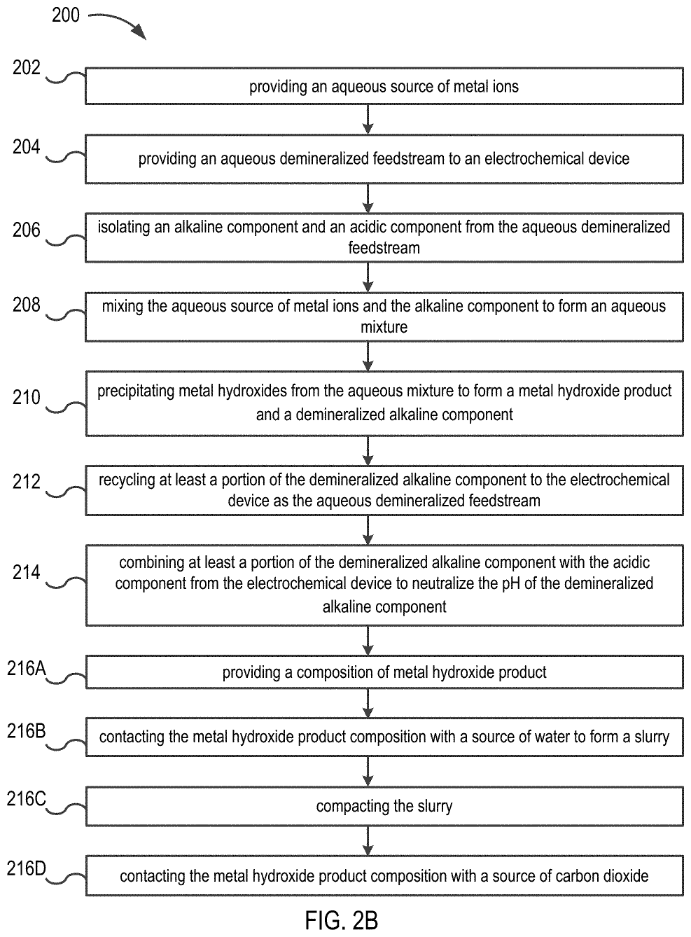

Referring now to FIG. 2A, some embodiments of the present disclosure are directed to a method 200 of making a cementitious compositions, concrete structural elements, etc., or combinations thereof. At 202, an aqueous source of metal ions is provided. As discussed above, in some embodiments, the aqueous source includes seawater, brine, brackish water, wastewater, or combinations thereof. In some embodiments, the aqueous source is naturally occurring, i.e., is sourced from nature. In some embodiments, the aqueous source is the product of a synthetic process, e.g., waste effluent from an industrial process. At 204, an aqueous demineralized feedstream is provided to an electrochemical device. At 206, an alkaline component and an acidic component are isolated from the aqueous demineralized feedstream. In some embodiments, the alkaline component and the acidic component are generated via an electrolysis process and isolated via the electrochemical device. In some embodiments, the electrochemical device includes one or more electrolyzers, electrodialysis cells, or combinations thereof. In some embodiments, the electrolyzer is membraneless. Exemplary electrolyzers and electrolyzer systems suitable for use with the systems and methods of the present disclosure are described in U.S. Utility Pat. No. 10,844,494, which is incorporated by reference herein in its entirety. At 208, the aqueous source of metal ions and the alkaline component are mixed to form an aqueous mixture. At 210, metal hydroxides are precipitated from the aqueous mixture to form a metal hydroxide product and a demineralized alkaline component. As discussed above, the rising pH in the aqueous mixture shifts the equilibrium of metal ion conversion to metal hydroxides towards the metal hydroxide products, which then precipitate out of solution. In some embodiments, the reaction converting Ca²⁺ to Ca(OH)₂ is shifted via the rising pH towards Ca(OH)₂, causing metal ions from the aqueous source to precipitate out in the form of Ca(OH)₂. In some embodiments, the reaction converting Mg²⁺ to Mg(OH)₂ is shifted via the rising pH towards Mg(OH)₂, causing metal ions from the aqueous source to precipitate out in the form of Mg(OH)₂. Precipitation of the metal hydroxide product also produces a demineralized alkaline component with a reduced concentration of metal ions. This demineralized alkaline component is useful because it can be reused in method 200 itself, but also because it can be processed into a demineralized product, e.g., demineralized seawater. As discussed above, demineralized seawater can be used to limit scaling on the surfaces of membranes of water desalination units, but can also simply be returned to the sea. At 212, at least a portion of the demineralized alkaline component is recycled to the electrochemical device as the aqueous demineralized feedstream. The demineralized alkaline component can then undergo additional electrolysis to generate higher pH alkaline components for subsequent precipitation of more metal hydroxide product at subsequent steps 210. At 214, at least a portion of the demineralized alkaline component is combined with the acidic component from the electrochemical device to neutralize the pH of the demineralized alkaline component, resulting in a demineralized aqueous source product, e.g., the demineralized seawater discussed above.

At 216, the metal hydroxide product is incorporated into a cementitious composition. While the exemplary embodiments of the present disclosure describe incorporating metal hydroxide and metal oxide products that have been isolated from aqueous sources into cementitious products, the present disclosure is not limited in this regard, as other embodiments of systems and methods of the present disclosure incorporate metal hydroxide and metal oxide products from other sources, including, e.g., reagent grade products generally available to the public from a variety of providers. In some embodiments, both reagent grade metal hydroxide and metal oxide products and aqueous solution-sourced metal hydroxide and metal oxide products are incorporated into the cementitious composition. As discussed above, the metal hydroxide products, e.g., those produced via steps 202-210, are highly useful in the production of cements and concretes. In some embodiments, Ca(OH)₂ is substituted for limestone in the production of traditional Portland cement. Without the need to utilize limestone in the traditional process, the CO₂ generated in the calcination of limestone to CaO is eliminated, reducing the overall carbon cost of producing Portland cement.

Referring now to FIG. 2B, in some embodiments of method 200, incorporating 216 the metal hydroxide product into a cementitious composition includes providing 216A a composition of metal hydroxide product. In some embodiments, at 216B, the metal hydroxide product composition is contacted with a source of water to form a slurry. In some embodiments, the source of water is liquid H₂O, gaseous H₂O, i.e., water vapor, or combinations thereof. In some embodiments, the slurry has a liquid-to-solids, e.g., water-to-solids, ratio of about 0.1 to about 0.5 by mass. In some embodiments, the slurry has a liquid-to-solids ratio of about 0.2 to about 0.3 by mass. In some embodiments, the slurry has a liquid-to-solids ratio of about 0.3 by mass. In some embodiments, at 216C, the slurry is compacted. In some embodiments, the slurry is compacted at a pressure of about 0 MPa to about 6 MPa. In some embodiments, the slurry is compacted at a pressure of about 3 MPa. At 216D, the metal hydroxide product composition is contacted with a source of carbon dioxide. The source of carbon dioxide can be any source having a suitable concentration of carbon dioxide therein. In some embodiments, at least a portion of the carbon dioxide is sourced from the acidic component. In some embodiments, the source of carbon dioxide is waste effluent from an industrial process. In some embodiments, the source of carbon dioxide has a CO₂ concentration of about 10% to about 30%. In some embodiments, the source of carbon dioxide has a CO₂ concentration of about 20%. When exposed to moisture and CO₂, Mg(OH)₂ converts to MgCO₃ in various form, e.g., hydromagnesite and nesquehonite, which provides strength. In some embodiments, the slurry is maintained in contact with the source of carbon, i.e., is “cured,” for greater than about 5 days. In some embodiments, the slurry is cured for greater than about 2 days. In some embodiments, the slurry is cured to about 2 days to about 5 days. In some embodiments, the temperature during steps 216B, 216C, and/or 216D is generally maintained at about 25° C. In some embodiments, the relative humidity in the environment around the slurry during steps 216B, 216C, and/or 216D is generally maintained at about 75% to about 85%.

In some embodiments, other additives are incorporated into the slurry at steps 216B, 216C, 216D, or combinations thereof In an exemplary embodiment, inert aggregate is included in the slurry which, upon curing, forms a concrete structural element. In some embodiments, steps 216A-216D are repeated to form multilayered concrete structural elements. In these embodiments, a first layer of slurry is provided and cured as discussed above. Then, additional layers of slurry can be provided and cured on the first layer. Layer-by layer, a concrete structural element can be formed progressively, resulting in a densified structure with enhanced strength and transport properties and substantially uniform carbon curing throughout the resulting multilayered element.

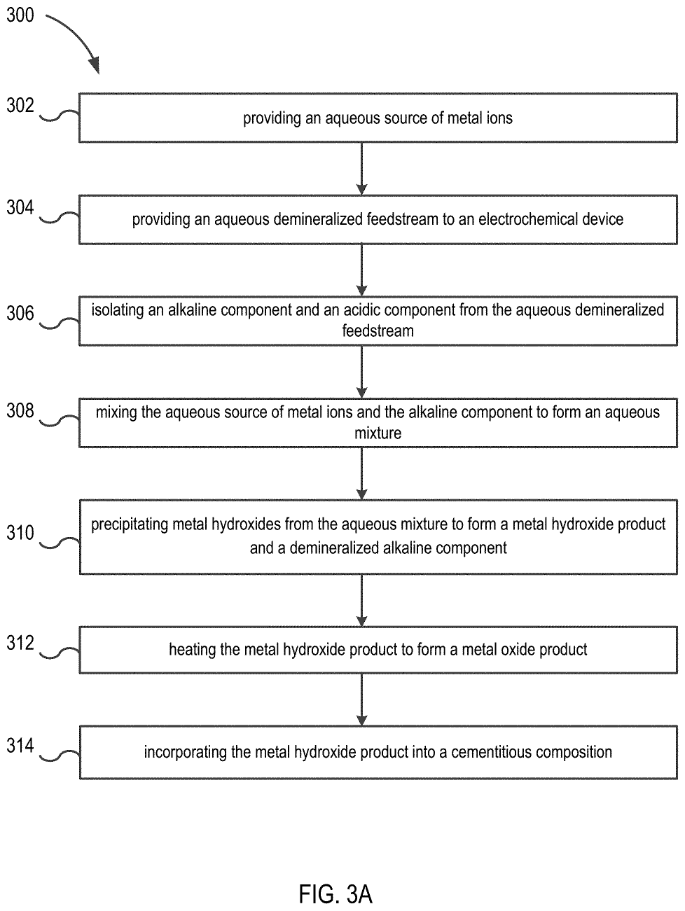

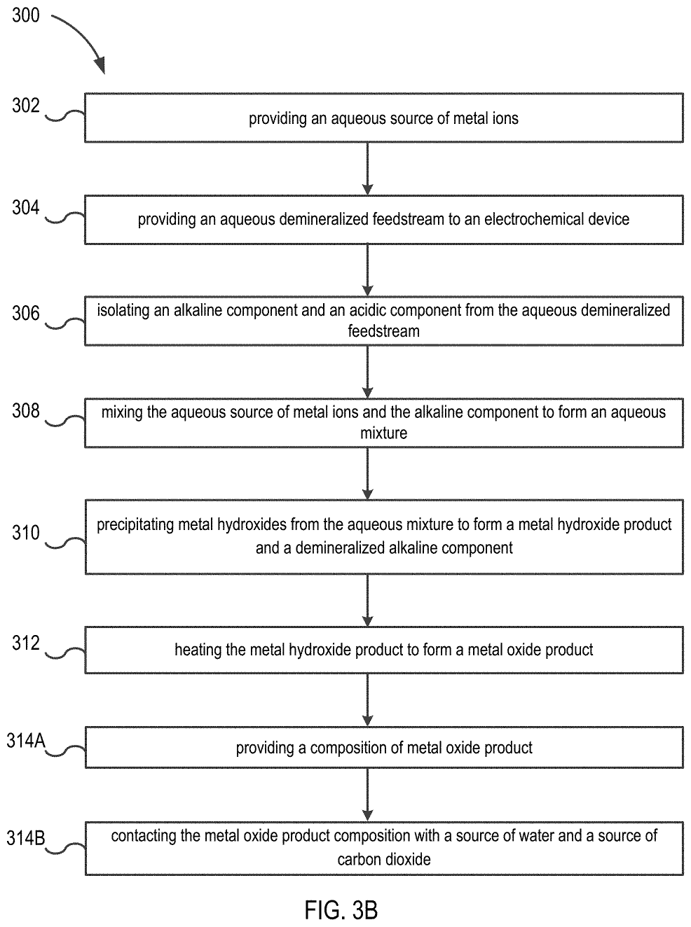

Referring now to FIG. 3A, some embodiments of the present disclosure are directed to a method 300 of making a cementitious composition utilizing metal oxides. Similar to method 200 discussed above, at 302, an aqueous source of metal ions is provided. At 304, an aqueous demineralized feedstream is provided to an electrochemical device. At 306, an alkaline component and an acidic component are isolated from the aqueous demineralized feedstream, e.g., via an electrolyzer and an electrolysis process. At 308, the aqueous source of metal ions and the alkaline component are mixed to form an aqueous mixture. At 310, as the pH rises in the aqueous mixture, metal ions from the aqueous source precipitate out as metal hydroxides to form a metal hydroxide product and a demineralized alkaline component. At 312, the metal hydroxide product is heated to form a metal oxide product. At 314, the metal oxide product is incorporated into a cementitious composition.

Referring now to FIG. 3B, in some embodiments of method 300, incorporating 314 the metal oxide product into a cementitious composition includes providing 314A a composition of metal oxide product. At 314B, the metal oxide product composition is contacted with a source of water and a source of carbon dioxide. In some embodiments, the metal oxide product composition is mixed with water to form a slurry. In some embodiments, other additives are incorporated into the slurry. In some embodiments, the additives include inert aggregates. In some embodiments, the additives include one or more salts, e.g., NaCl. In some embodiments, the additives include one or more carbonates. In these embodiments, the carbonates can be provided from any suitable source. In some embodiments, the carbonates are waste materials from another industrial system or process. In some embodiments, the carbonates are naturally occurring minerals. In some embodiments, the carbonates are generated within method 300 itself. In these embodiments, at least a portion of the demineralized alkaline component is contacted with a source of carbon dioxide to form a carbonate product, which is then added to the slurry. In an exemplary embodiment, the demineralized alkaline component includes a concentration of alkali metal hydroxides, e.g., NaOH. After allowing the metal hydroxide product to settle out of solution, a portion of the demineralized alkaline solution can be sent to a carbonation tank where CO₂ reacts with NaOH to form sodium carbonate and/or sodium bicarbonate consistent with the reactions below:

NaOH+CO₂→NaHCO₃ (pH<8)

2NaOH+CO₂→Na2CO₃+H₂O (pH>10)

The sodium carbonate and/or sodium bicarbonate can then be provided to the slurry. These carbonates are beneficial in that they can accelerate the hydration of the metal oxides, forming additional reaction products that can provide strength gains in the structural elements made from the cementitious compositions of the present disclosure. In some embodiments, the source of water is liquid H₂O, gaseous H₂O, i.e., water vapor, or combinations thereof. In some embodiments, the slurry has a liquid-to-solids, e.g., water-to-solids, ratio of about 0.1 to about 0.5 by mass. In some embodiments, the slurry has a liquid-to-solids ratio of about 0.2 to about 0.3 by mass. In some embodiments, the slurry has a liquid-to-solids ratio of about 0.3 by mass.

The slurry is contacted with a source of carbon dioxide. The source of carbon dioxide can be any source having a suitable concentration of carbon dioxide therein. In some embodiments, at least a portion of the carbon dioxide is sourced from the acidic component. In some embodiments, the source of carbon dioxide is waste effluent from an industrial process. In some embodiments, the source of carbon dioxide has a CO₂ concentration of about 10% to about 30%. In some embodiments, the source of carbon dioxide has a CO₂ concentration of about 20%. In some embodiments, the slurry is cured for greater than about 2 days. In some embodiments, the slurry is cured to about 2 days to about 5 days. In some embodiments, the temperature during step 314B is generally maintained at about 25° C. In some embodiments, the relative humidity in the environment around the slurry during step 314B is generally maintained at about 75% to about 85%.

In some embodiments, other additives are incorporated into the slurry at steps 314B. As discussed above, in an exemplary embodiment, inert aggregate is included in the slurry which, upon curing, thus forms a concrete structural element. In some embodiments, steps 314A-314B are repeated to form multilayered concrete structural elements. In these embodiments, a first layer of slurry is provided and cured as discussed above. Then, additional layers of slurry can be provided and cured on the first layer. In some embodiments, the layers are extruded. Layer-by layer, a concrete structural element can be formed progressively, resulting in a densified structure with enhanced strength and transport properties and substantially uniform carbon curing throughout the resulting multilayered element.

When exposed to moisture, the metal oxide product hardens as oxides hydrate to form hydroxides. In the embodiments utilizing carbonate additives, this hydration is accelerated. When exposed to CO₂, hydroxides convert to hydrated carbonates in various forms, e.g., hydromagnesite and/or nesquehonite in the case of magnesium, which can provide strength gain. Several studies have shown that MgO cement can capture 1.1 ton of CO₂ per 1 ton of MgO during accelerated CO₂ curing. Thus, embodiments of method 300 produce CO₂-negative concrete considering zero CO₂ emission during the harvesting and calcination of Mg(OH)₂, and carbon curing to form the final solid MgO binder.

In some embodiments, the metal oxide and/or metal hydroxide products are incorporated into a cementitious composition by pelletizing the products with sprayed water. In these embodiments, the metal oxide and/or metal hydroxide products are combined with water as it is sprayed on a surface, such as a pelletizer disc. Product powder particles stick to each other and start to agglomerate during the pelletizing process. In exemplary embodiments with a pelletizer disc , the rotation of the disc can be maintained until the aggregates reach the desired particle size. The particles are then exposed to a carbon dioxide consistent with the embodiments described above. The result is cementitious pellets including carbonates which are lightweight and advantageous for use as aggregate replacement in concrete structural elements.

### EXAMPLE

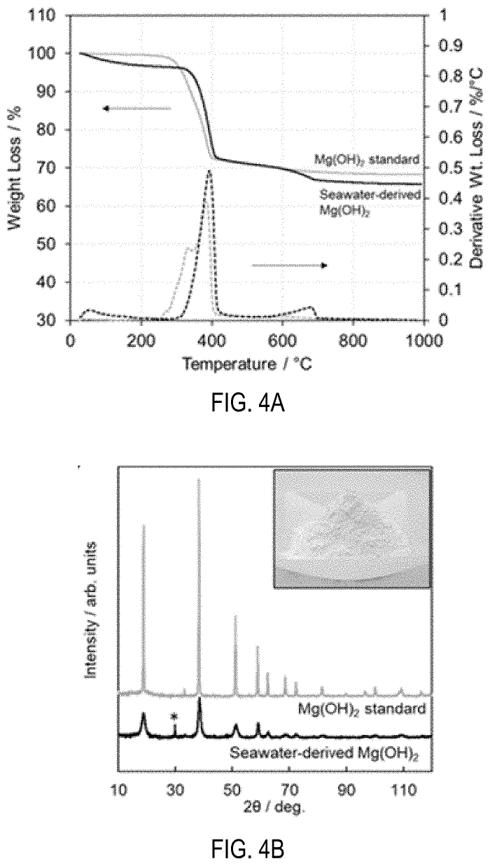

Seawater-derived Mg(OH)₂ was obtained by precipitation using 4.86 g NaOH per L of seawater and rinsed 2 times with 48 L of deionized water. The seawater-derived Mg(OH)₂ was compared to reagent grade Mg(OH)₂ (Sigma Aldrich) via TGA and XRD in FIGS. 4A-4B, respectively.

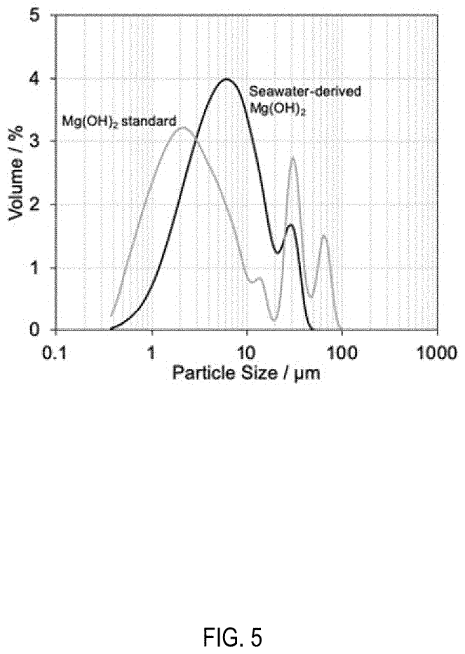

The precipitated Mg(OH)₂ formed a dried filter cake and was crushed into a fine powder that was white in color, as shown in the inset in FIG. 4B. This powder was divided into two portions—one passing 75 μm and the other passing 53 μm sieves—and the combination proportion that gave the best match to the standard brucite control powder was used. Particle size analysis of a suspension of the cement powder showed that the particle size ranged from 0.4 μm to 75 μm with the bulk of material being less than 20 μm (see FIG. 5).

From a TGA scan of the seawater-derived cement, the presence of Mg(OH)₂ is observed. However, besides the dominant peak associated with Mg(OH)₂, smaller peaks associated with residual water and an unidentified peak were also observed. Consistent with TGA results, XRD patterns taken of the seawater-derived precipitate match brucite Mg(OH)₂ (PDF #44-1482). The only non-Brucite reflection is associated with a minor peak around 2θ=29.5°, which is consistent with CaCO₃ (Calcite, PDF #05-0586). The unidentified peak in the TGA was thus confirmed to be CaCO₃. The composition of raw Mg-cement by weight was then determined to be: ˜84.1% Mg(OH)₂, ˜3.5% water, and ˜9.3% CaCO₃. Without wishing to be bound by theory, the expected inert nature of CaCO₃ in a carbon dioxide environment implies it will exist as an impurity and will effectively reduce the “active” proportion in the cement—the brucite. This may lead a lower strength as compared to purer Mg(OH)₂.

The Mg(OH)₂ powder was mixed with water to yield a water-to-solids ratio of 0.3, then cast in cylindrical molds (1 in×1 in). Each cylindrical specimen was compacted at 3 MPa for two minutes, then demolded and cured in a carbon-rich environment (20% CO₂ concentration, 25° C.±1° C. operation temperature, and 80%±5% relative humidity). The cylinders were subjected to compression loads to observe their performance and were later processed for characterization.

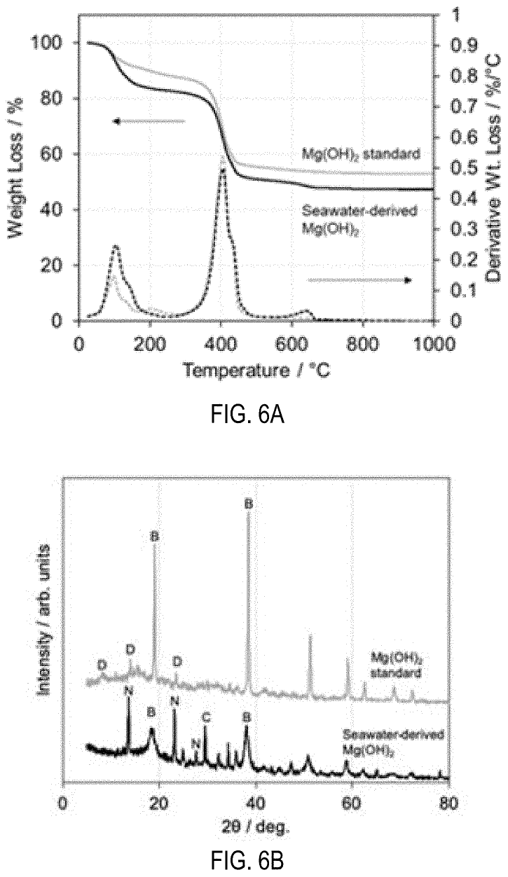

Referring now to FIGS. 6A and 6B, to understand product formation upon curing, the cylindrical specimens were crushed back into a powder and subject to TGA and XRD. TGA scans of cured samples showed noticeable new peaks over raw samples up to ˜250° C. (see FIG. 6A). These are expected to be due to carbonates. The characteristic peak from residual brucite is also visible. Some peaks from carbonates overlap with brucite peak. The peaks may belong to such carbonates as hydromagnesite, dypingite, or nesquehonite but given overlaps, TGA did not distinguish them individually.

The presence of carbonates was confirmed via XRD in both the seawater and standard Mg(OH)₂ (see FIG. 6B). Results from the cured standard brucite indicate presence of hydromagnesite/dypingite. On the other hand, XRD on cured seawater magnesium hydroxide samples showed that the predominant carbonate phase was nesquehonite, unlike the standard brucite. Without wishing to be bound by theory, the difference in carbonate phases observed between the two cured systems can be attributed to differences in the crystal structure, particle shape, particle size distribution, surface roughness, and trace impurities of the source brucite, and even under the same curing conditions and mix design, the attributes of the brucite can lead to different conditions locally within the material and result in the formation of different polymorphs, where temperature, pressure, CO₂ concentration, and relative humidity will influence carbonate phase formation.

The compressive strength of mixtures composed of standard Mg(OH)₂ subjected to carbonation curing for 3 hours, 2 days and 5 days were obtained. Additionally, compressive strength after 2 days carbonation curing was compared between mixtures composed of standard and seawater-derived Mg-cement. Each tested mix had a water-to-binder ratio of 0.3.

The mass, and density, of the cylinders were obtained prior to carbonation curing and were found to be comparable: 1.49 g/cm³ for commercial brucite and 1.44 g/cm3 for seawater-derived precipitated Mg(OH)₂. The mass change over 2 days was found to be the same at +13%. For the standard Mg-cement, the compressive strength increased with time, where the strength was 23 MPa at 3 hours, 33 MPa at 2 days, and reached 71 MPa at 5 days. The compressive strength of seawater specimens at 2 days was 23 MPa. Without wishing to be bound by theory, this may have occurred due to the properties of both the raw material and the carbonated material, namely, a difference in particle size distribution may affect packing behavior during compaction, which in turn may affect permeability for carbonation. Additionally, the PSD and particle morphology also affect the surface area available for products to form. CO₂ curing also leads to formation of different carbonates and these have distinctly different morphologies. Further, the strength of the binding matrix depends on product morphologies. For instance, rosette like structures are more favorable for strength, i.e., better integrity, than needle like structures. The strength observed in the exemplary embodiments described above is strong enough considering the early compressive strength of ordinary Portland cement concrete. With longer curing durations, the strength of the seawater magnesium samples should continue to enhance considering the compressive strength development results of standard magnesium hydroxide groups.

The methods and systems of the present disclosure are advantageous in that they utilize carbonated metal hydroxides and oxides to produce compositions with compressive strengths suitable for use as construction materials. The metal hydroxides and oxides are carbonated through a curing process to sequester environmental carbon dioxide, reducing or eliminating the carbon footprint associated with traditional methods of cement and concrete manufacturing. Additionally, the produced compositions reach compressive strengths comparable to those of traditional, reactive metal oxide fabrication techniques, but with reduced water demand and elimination of highly energy intensive calcination steps. By way of example, conventional limestone feedstock for Portland cement manufacturing is excavated, crushed, and then sintered with other materials at temperatures reaching ˜1450° C. in a cement kiln to produce clinker. This traditional process directly releases CO₂ during calcination of CaCO₃ (CaCO₃→CaO+CO₂), which makes up ˜50-60% of total emissions of cement production. The systems and methods of the present disclosure can produce an electrochemically harvested Ca(OH)₂ powder that is fed into existing cement plants/kilns through partial to full replacement of the limestone. By using Ca(OH)₂ as a feedstock, indirect CO₂ emissions associated with the harvesting or direct CO₂ emissions during the calcination process to obtain CaO can be eliminated.

Finally, the systems and methods are advantageous in that the metal hydroxides and oxides used as construction materials can be sourced from mineralized aqueous solutions. Importantly, the production of these metal hydroxide/oxide products via electrolysis can be carried out without any CO₂ emissions if the electricity used to power electrolysis is generated by renewable solar and wind. Hydroxides generated by electrolysis can then be calcined to produce oxide products as necessary, releasing steam in the process. Obtaining the metal hydroxide/oxide product has the added benefit of evolving low pH demineralized streams as a byproduct, which can be recycled to help create yet more product, or can be neutralized for use in parallel water desalination systems and processes, or for return to the sea.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. A method of making a cementitious composition, comprising:
providing an aqueous source of metal ions;
providing an aqueous demineralized feedstream to an electrochemical device;
isolating an alkaline component and an acidic component from the aqueous demineralized feedstream;
mixing the aqueous source of metal ions and the alkaline component to form an aqueous mixture; and
precipitating metal hydroxides from the aqueous mixture to form a metal hydroxide product and a demineralized alkaline component, the metal hydroxide product including metal ions from the aqueous source of metal ions.

2. The method according to claim 1, wherein the aqueous source includes seawater, brine, brackish water, wastewater, or combinations thereof.

3. The method according to claim 1, further comprising:
recycling at least a portion of the demineralized alkaline component to the
electrochemical device as the aqueous demineralized feedstream.

4. The method according to claim 3, further comprising:
combining the acidic component with at least a portion of the demineralized alkaline component as a demineralized aqueous source product.

5. The method according to claim 1, further comprising:
incorporating the metal hydroxide product into a cementitious composition.

6. The method according to claim 5, wherein incorporating the metal hydroxide product into a cementitious composition includes:
providing a composition of metal hydroxide product; and
contacting the metal hydroxide product composition with a source of carbon dioxide and a source of H₂O.

7. The method according to claim 6, wherein contacting the metal hydroxide product with a source of carbon dioxide and a source of H₂O further comprises:
providing H₂O to the metal hydroxide product to form a slurry having a water-to-solids ratio of about 0.2 to about 0.3 by mass;
compacting the slurry at a pressure to form a compacted slurry; and
exposing the compacted slurry to an environment having a concentration of carbon dioxide of at least about 20%.

8. The method according to claim 7, wherein the pressure is about 3 MPa.

9. The method according to claim 7, wherein the compacted slurry is exposed to the carbon dioxide for about 2 to about 5 days.

10. The method according to claim 7, further comprising repeating the step of contacting the metal hydroxide product with a source of carbon dioxide and a source of H₂O to additively form a multilayered concrete structural element.

11. The method according to claim 6, wherein contacting the metal hydroxide product with a source of carbon dioxide and a source of H₂O further comprises:
pelletizing the metal hydroxide product composition with sprayed water; and
exposing the pelletized metal hydroxide composition to the source of carbon dioxide.

12. The method according to claim 1, wherein the metal ions include magnesium, calcium, or combinations thereof.

13. A method of making a cementitious composition, comprising:
providing an aqueous source of metal ions;
providing an aqueous demineralized feedstream to an electrochemical device;
isolating an alkaline component and an acidic component from the aqueous demineralized feedstream;
mixing the aqueous source of metal ions and the alkaline component to form an aqueous mixture;
precipitating metal hydroxides from the aqueous mixture to form a metal hydroxide product and a demineralized alkaline component, the metal hydroxide product including metal ions from the aqueous source of metal ions;
heating the metal hydroxide product to form a metal oxide product; and
incorporating the metal oxide product into a cementitious composition.

14. The method according to claim 13, wherein incorporating the metal oxide product into a cementitious composition further comprises:
mixing the metal oxide product with a source of water to form a slurry; and
exposing the slurry to a source of carbon dioxide.

15. The method according to claim 14, wherein exposing the slurry to a source of carbon dioxide includes:
extruding a first layer of slurry in an environment having a concentration of carbon dioxide of about 20%; and
extruding at least one subsequent layer of slurry over the first layer of slurry.

16. The method according to claim 13, wherein incorporating the metal oxide product into a cementitious composition further comprises:
pelletizing the metal oxide product with sprayed water; and
exposing the pelletized metal oxide product to carbon dioxide.

17. The method according to claim 14, further comprising:
contacting at least a portion of the demineralized alkaline component with a source of carbon dioxide to form a carbonate product; and
providing the carbonate product to the slurry.

18. The method according to claim 13, wherein the metal ions include magnesium, calcium, or combinations thereof.

19. A system for making a cementitious composition, comprising:
an aqueous source of metal ions;
a membraneless electrolyzer including:
a first input in fluid communication with an aqueous demineralized feedstream,
a first outlet stream including an alkaline component, and
a second outlet stream including an acidic component;
a precipitation tank in fluid communication with the first outlet stream and the aqueous source of metal ions, the precipitation tank including a demineralized alkaline component outlet stream;
a neutralization tank in fluid communication with the second outlet stream and the demineralized alkaline component outlet stream, the neutralization tank having a third outlet stream including a demineralized aqueous source product; and
a recycle stream in fluid communication with the demineralized alkaline component outlet stream and the first input to provide least a portion of the demineralized alkaline component outlet stream to the membraneless electrolyzer as the aqueous demineralized feedstream.

20. The system according to claim 19, wherein the metal ions include magnesium, calcium, or combinations thereof.
